(19) United States
(12) Patent Application Publication
(10) Pub. No.: US 2020/0183924 A1
(43) Pub. Date: Jun. 11, 2020

(54) Computer program for computational and statistical analysis based on breadth first search software system linkage for optimal useful data-point patterns and probabilistic data determinants in search query results

(71) Applicants: Arya Deepak Keni, Woodbridge, NJ (US); Michael Hahn, Stanford, CA (US)

(72) Inventors: Arya Deepak Keni, Woodbridge, NJ (US); Michael Hahn, Stanford, CA (US)

(21) Appl. No.: 16/735,608

(22) Filed: Jan. 6, 2020

(51) Int. Cl. G06F 16/2455; G06N 3/08; G06F 16/242; G06N 7/00

(52) U.S. Cl. CPC G06F 16/2455; G06N 7/005; G06F 16/242; G06N 3/08

(57) ABSTRACT

This patent discloses methods, systems and computer program product for producing optimal search requests based on certain user queries and on certain user specific data. The patent describes in detail of a software system encapsulated in the form of a search engine, using the process of serendipity in network systems (digitally) and drawing data from previous user searches, user data, user specifics, and potentially utilize the data and results for more lucrative job-related opportunities. This patent describes in detail the mathematical functions, the predictive programming, the binary network formation, and the storage of constantly evolving data into one system and its manipulation for user directed searches and user beneficial results.

### RELATED APPLICATIONS

None

### BACKGROUND & FIELD OF THE INVENTION

### Field of the Invention

The System, Method and computer program product serve to optimally output the most desired and efficient search results and data points for a specific type of user (say in a certain profession), based off certain pre-filled or query based data pointers. Search algorithms like google are depth first algorithms giving specific search results, based off a query, which is extremely useful for users to reach to the data point they desired, but poses a challenge in outputting related and optimally useful data points, closely related to the search query, and exactly of the search query (like google does, based off language processing filters to find results with similar content/language).

### Background of the Invention

Many people often want to find answers quickly and of the best quality, often not knowing what the latter is exactly, along with not knowing what they might stumble upon in their search processes. This computer program product aids to use sophisticated algorithms to perfectly predict, compute, and display said search results that might be This search tool will aid to find any data, based on the context (ranging from finding and networking artists of similar interests, resource linking for entrepreneurs and so on), and optimally display the result based off the user parameters asked. This application would be useful, as it involves the social networking concept of serendipity, where a user would benefit more through the results that weren't expected to be found, than what was expected, here done by an advanced ML (machine learning) and DL (deep learning) algorithm tuned in by specially designed mathematical functions and user inputs. This software tool is based off probabilistic and real-time learning logic, which is essentially using rising technology to provide a new perspective to the usual search result.

### SUMMARY

### Brief Summary of the Invention

The present invention incorporates a number of known technologies into a novel system for making query and personality-based determinations. More particularly, embodiments of the present invention use a mobile application client (an “App”) and ability for the mobile application client or non-mobile application client to perform search or calculations and communicate with other software sources over a data communications network. The proposed method, system or computer program product (accessible with/out internet connection) will solve all of the above stated problems by automating all possible ‘useful’ outputs by means of mathematical manipulation of functions and complex computations of numerous data inputs instantaneously (from the new functions, or the original) (dependent on type of calculation or data retrieval to be performed) and predictions based off evolutionary algorithms (such as pure ‘deep learning’, pure ‘artificial intelligence based analytics’ to name a few) which develop and improve functionality with time and usage.

### BRIEF DESCRIPTION OF DRAWINGS

FIG. 1. Depicts the main back-end algorithm (Optimality Algorithm) for the query processing of the user, and the overlay of the involved elements, functionality and data in the processing flow of the final result set.

FIG. 2. Depicts the sub-algorithm to process, gather, sort and store the ambient data type and module into a wireless cloud functionality, ready for access anytime by the main back-end algorithm

FIG. 3. Depicts the sub-algorithm to process, gather, sort and store the user data type and module into a wireless cloud functionality, ready for access anytime by the main back-end algorithm

### SPECIFICATIONS—DETAILED DESCRIPTION

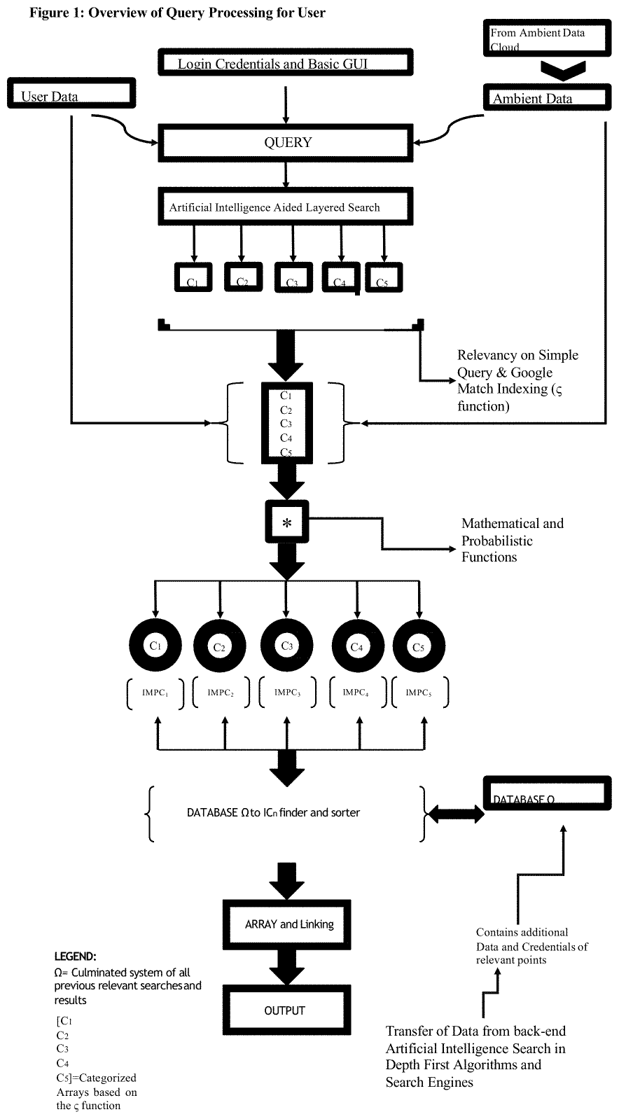

Referring to FIG. 1, there will be an explanation of how the user will receive the search results for the desired uses, the search algorithm will be initiated by an input of a search query, including but not limited to: sentences, words, letters, numbers and symbols. Assuming the user has previously logged into this search engine, using the usual login credentials of an email ID and a password to validate the user's authenticity, the search query is then proceeded forward into a conversion to a coherent ‘string’ format (a format with every type of variable, such as a number, or a symbol, converted into an equivalent ‘word’ form by computer conversion codes, such as ASCII). This information will be initially taken in through the data system by a basic credential-filling portal with a screen interface and user guidance for the said data filling process.

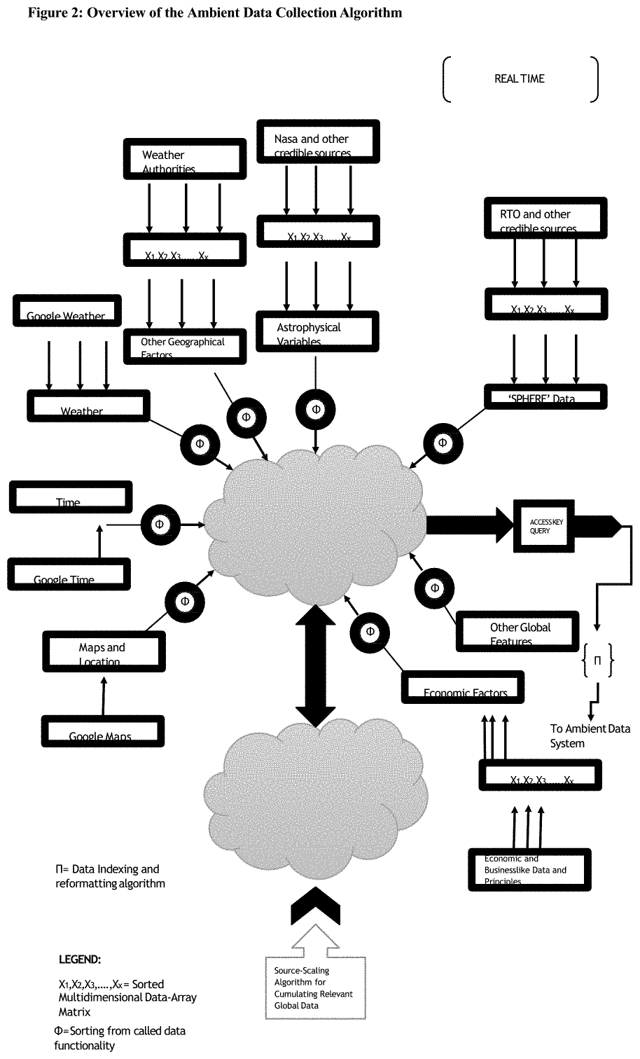

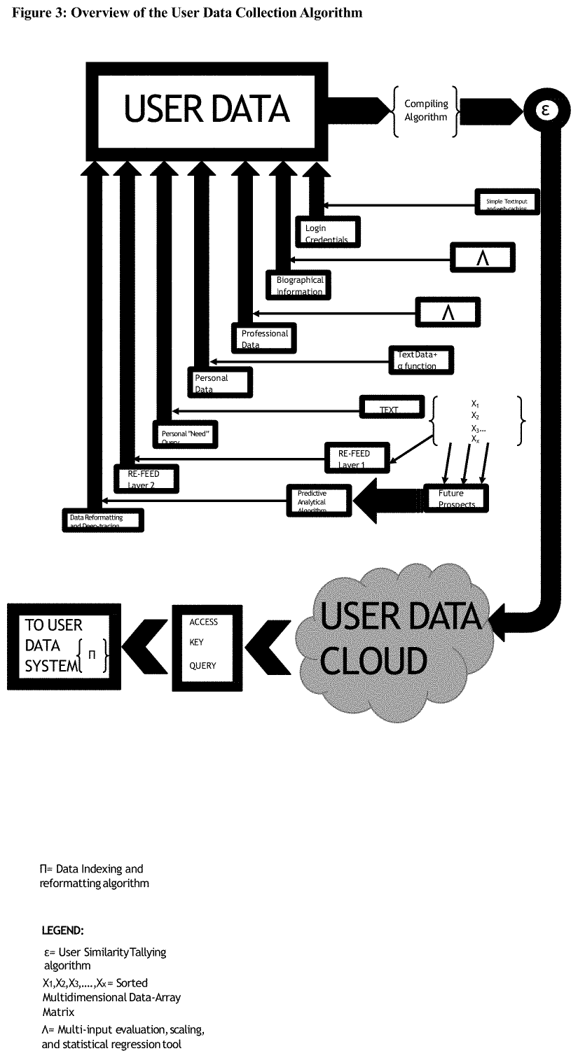

Later, this coherent string, which is stored into the system's common database, is then retransferred into another multivariable matrix of data (a table of variables containing the ambient data, the current input, and the user data). The ambient data and the user data is taken for processing at the very second of the query being processed through the cloud getting or storing data from other sources or other computations. The significance of the timing of drawing in data from the ambient and user data sources, as well as its constituent processes to formulate the cumulative data used at the time of the query will be explained in detail while referring to FIGS. 2 and 3 respectively.

All these data sets are utilized parallelly to go through an artificial intelligence aided layered search, which essentially goes through the query as one layer of searching and find out implied terms, direct key terms, and related terms for search results, much like google or any other conventional search engine used today. This data will be stored in a particular matrix bin under the family name ‘C’, that of C₁.

The artificial intelligence algorithm is used to aid in evaluation of the second layer of search, where an evolutionary algorithm, which updates its terms of processing based on certain parameters (updating its functionality with a set of iterations passing by). Here the parameters would be the user data for evaluation. The query's processed with the user data in mind will be categorized into two bins, data and search results comprising that of the user's importance and that which is not of the user's importance, contained in C₂. This distinction will be made solely on the basis of tallying, computing, and predicting the search result's likeability for the user, to formulate a mathematical coefficient which will further sub-categorize the two bins stated above (where a certain degree of ‘importance and likeability’ will comprise data (search queries) of a certain coefficient).

The third layer of artificial intelligence aided layered search would be that of the parameter being the ambient data. These results will be processed in a similar fashion as that of the user data in context of the query, but will be computed for its respective coefficient differently. The results will be contained in C₃.

The fourth layer of artificial intelligence aided layered search would be that of the parameter being the ambient data and the user data (both being used for evaluation simultaneously). These results will be processed in a similar fashion as that of the user data in context of the query, but will be computed for its respective coefficient differently. The results will be contained in C₄.

The fifth layer of artificial intelligence aided layered search would be that of the comparison of all the previous 4 bins with all the search results which are as far as seven nodes (as a default value) away from network (of relevant search results) formed by the Artificial Intelligence with the central query. The extent of relevancy can be chosen by the user in the ‘user data’ section, which decides the number of nodes of relevant results to include in the comparison from the central query. The ‘searches’ present in the complete set, and not matching the stored data in the previous 4 bins are stored into this fifth bin, C₅.

The functionalities described from [0010] through [0014] are re-validated for the data bins being correctly sorted via running the same algorithm again, as well as the relevancy on the simple query. Each match in each bin is indexed with a unique identification string (complex and randomly generated without overlap) for security purposes and for safe data-call procedures within the program. This functionality is called the ç functionality for convenience during function invocation. The layers proceed as an initially known length of iterations (here, the length being 5), with each layer completing its algorithmic procedure after another.

After the sorting of the 5 bins for further processing, the 5 bins are sequentially passed through the Mathematical and Probabilistic Function as implicit inputs. This said function evaluates each data point in each bin in direct reference to the most probable type of use of the data point, say, data point A in bin C₃ containing 3 links and a research article from a verified source can be most probably used for ‘validating and obtaining further information on most helpful banking investment strategies’. This purpose is defined by initially scanning each content under the data point and using the Deep Learning Algorithm (which is the Generic type for evaluating implied meanings and human-like features) and then processing it through the mathematical and statistical formulae for such abstract non-numerical data cells and then a certain ‘probability of use’ index is given (based off the quality filtering and the likelihood for the data to help the user (through the Generic Deep Learning Algorithm)) (much like the calculation of the probability of ‘love’ for two user profiles on popular dating websites and mobile applications).

After the processes described from [0010] through [0016], the bins are re-segregated into separate memory locations (for each bin), and an [IMPCₙ] labelled matrix is assigned to each bin, where each data point, and each calculated coefficient (probability of use coefficient, extent of help coefficient (the magnitude of ‘help’ that data point will do to the user in context of the necessity of the user), and the relevancy coefficient) are assigned to a specific matrix location for easy access later in the algorithm. Here there are 5 matrices as n goes from 1 to 5 inclusive, for the 5 respective bins.

The matrices are separately run through the Database called ‘Ω’ which has an endless matrix component, storing all the past searches from the time of registry of the user. The registry is important as it assigns and stores data specific to the singular user in its local variable(s) index space (on the specific device), for a quicker caching process, as opposed to all data specific to each user (and for all users) being on a singular network, which would then be tallied and called.

This Database will already have the data values for each past data-set as described in [0017] and would then be tallied for similar values, or values within a certain range with the current [IMPCₙ] matrices. After matching, indexing, and sorting all the data points in the previous and current search into sets of singular infinite length arrays, (each bin is separated, and the data from Database Ω is added into each bin space as well, after a space extension of each bin in correspondence to the amount of data to be added). The data from the database is transferred quickly and without any monotone routine (such as searching each space location and then tallying) by an Artificial Intelligence Search in Depth First Algorithms (algorithms that exploit each networked link starting from a data point and extract relevant data in this case) and Search Engines on the database to instantly sort and tally these data points through intelligent analysis and predictions of the linking of each point in the respective bin. This process is done at the back end due to there being another process being simultaneously run, that of the current bins being sorted, so the database indexing needs to be done beforehand to feed into the current bins.

All the data is outputted with each data link (article, paper, video, and similar media) one below the other, with a short description accompanying it (usually the title and description within the content itself, which is done by the Linking process before the output procedure begins). The coefficients are displayed beside each link and the values are parsed onto a scale (left end being low and right end being high (in value)), for the understanding of the user. The meaning of each technical term used which appears on the user Application Program Interface is explained beside the technical term itself. Each page of results has 25 results, and are also displayed with each bin parameter above the respective bin contents (for easy user reference). The results appear below the query input space.

Referring to FIG. 2, the ambient data (stored into a matrix with each type of data (links and usual data types) separated) are obtained for feeding into the main algorithm at the time of the query search is as follows: When the query is initiated, the ambient data cloud is accessed and all the data is used after converting it into a readable form by the algorithm (by assigning each point a specific and randomly generated, non-repeating index) by the ‘Π’ function.

The ‘Φ’ functionality sorts each obtained data from each field of relevancy and then transfers it for storing into the user specific ambient data cloud. Irrespective of the type of search or the user data nature, all these fields are processed and transferred.

In real time, the ambient data stores astrophysical variables and astrophysical data from credible related sources such as NASA. Data about the biosphere, lithosphere, hydrosphere, and the atmosphere is also obtained from credible sources such as pollution authorities and so on. Weather, location data and geographical features of nearby areas are also obtained from weather authorities, google maps and google weather and stored. The time at the moment of processing the query is also taken into account and stored by either the local time-keeping algorithm on each device, or through online means. Economic Data is also taken into account (Exchange rates at the moment, GDP of the nations, policies (national and international), tax and subsidies) from credible sources, articles, and research papers and from stock markets. Each data in a field is indexed and pre-arranged beforehand into a linear fashion, before the invocation of the ‘Π’ function and the ‘Φ’ function.

All these fields in context of previous search-initiated stored data, and data in the fields in other user systems are also transferred to the user-local cloud, and sorted into the existing field spaces. This is done by taking immense amounts of data referred to in [0021] from the global wireless network and source-scaling it (compressing and getting rid of the repeated data) into an intermediate cloud system, which then transfers it to the user's ambient data cloud.

This data can be represented on the USER API as a separate link present above the query box, which when clicked would depict each field and each parsed source link in a tabular fashion. Since the exact data taken by the AI (Artificial Intelligence) and DL (Deep learning) algorithms can only be processed local to the transferring and evaluating of the data, it cannot be formatted into a human-understandable form, and hence the exact points taken in each link are not depicted.

Referring to FIG. 3, the user data, which is filled in the form of sub-page in the user (specific) information page. The User Name, Password, cloud backup linking and such is done through the usual web-caching procedure after verification. The biographical information and the professional data (all possible questions relating to the profession of the person) are evaluated and inputted through the ‘Λ’ function, which performs multivariable analysis and statistical measures (on existing knowledge pertaining to these data points) to derive implications about these inputs. Personal Data is taken in through text inputs (with guided questions on the matter) and evaluated by the ‘α’ functionality. This functionality does a similar function as the ‘Λ’ function, but in context of personal data. Since they operate on different data sources, they are regarded as different data sources.

If the user has a long term goal to find, such as maybe an optimal investor in their business, or a revolutionary and inspirational art style for their project, (these two were examples for understanding) the goal is inputted and will be used in relevant searches as the key guiding term, which is used for direct word tallying or for an implied meaning or related term search through a depth-first search.

This data is reformatted for efficient parsing, and re-fed into the cloud system (along with its individual components). To analyse the users future prospects regarding personal data, professional data and personal need, a predictive analytical algorithm is run through to determine these future prospects (an Artificial Intelligence based data tracing system is utilized to predict the ‘trajectory’ of each data point based on ‘smart-learning’ systems in the program). The data obtained is then reformatted and fed into the system.

The data under the ‘user data’ matrix is then compiled and made easily readable for the system. The ‘ε’ function is then invoked to tally these stored values with the values of any other user having any similar value or type of value, (like similar profession, goal and so on). These users pop up in the search results panel under like-minded contacts' for the user to connect and collaborate with, especially in the case of a ‘goal’. It is the user's choice to utilize those contacts. This data is transferred into the User Data Cloud under the permanent memory section (since most of this data is unlikely to change). The permanent memory guarantees no re-caching of data when called into a function. In the case of a change of any of the data aspects done by the user (by editing the sub-page of the information page), the whole permanent memory location is re-written with the new data, (the unchanged data remains). When the data is called at the moment of the query being processed, the cloud transfers and indexes each stored value to the main algorithm through the ‘Π’ function.

In the fashion described from [0020] to [0027] above, the User and Ambient Data Systems are incorporated into the main Optimality Search Algorithm, and all relevant user-understandable data is formatted and displayed in a convenient manner with explanations for all algorithm utilized terms. There are separate links and pages for the separate kind of and used data for user reference later if needed.

What is claimed is:

1. A set of systems and methods to analyze a network of linked data points through a specified search network, based on mathematical equations calculating additional parameters to lead to the optimal data results as required, paired with a software interface to input a search query and relational parameters such as the type of data entered for the most optimal output, based on the relational parameters. These sets and methods will have some key functionalities:

[symbol]

2. The presence of an optimality functionality systems by using the user data and inputs throughout system usage to constantly update on preferences, probability of usefulness of a particular data point (say a website), and the preferred route of narrowing the data points from the network of data, governed by a defined network linked by certain parameters, set by the user or adapted to by the algorithms mentioned in claim 1, for the setup of the data architecture beneath the search query.

3. The presence of an DL (Deep Learning), AI (Artificial Intelligence), PA (Predictive Analytics), Statistical and Coefficient Assigning (Rating) (CA) algorithm, all methods referring to claim 1, to learn and adapt from the user interaction and inputs for a change in the processed parameters over time, which as an append to the basic DL, AI, PA and CA program(s), but having these relational parameters aiding its learning process, and the updates process after interaction with a set of results.

4. The presence of methods of mathematical functions to evaluate complex, non-numeric, and constantly updating variables and data to accurately compute and store semi-processed (in regard of the full output) data into the systems' synopsis algorithm, referring to claim 1.

5. A computer program product to effectively bundle all related network data and software functionalities to into one encapsulated accessible application via a user-interactive interface.

6. The presence of multiple cloud systems to network singular and multiple user data and different aspects of data for ready storage and utilization in the aspects described in claim 1.

7. The presence of a user-understandability system to let the user informatically understand all the utilized terminologies, ratings, coefficients, related links and utilized links in a manner most convenient for the use and scrutiny of the user, as described in claim 1.
